(19) United States
(12) Patent Application Publication
(10) Pub. No.: US 2010/0169298 A1
(43) Pub. Date: Jul. 1, 2010

(54) Method And An Apparatus For Information Collection

(75) Inventor: Changzhong Ge, Beijing (CN)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: H3C TECHNOLOGIES CO., LTD., Hangzhou (CN)

(21) Appl. No.: 12/645,098

(22) Filed: Dec. 22, 2009

(30) Foreign Application Priority Data
Dec. 31, 2008 (CN) 200810247454.3

(51) Int. Cl. G06F 17/30; G06F 3/00

(52) U.S. Cl. 707/707; 715/760; 707/E17.108

(57) ABSTRACT

The present invention discloses a method and an apparatus for collecting information. The technical solution of the invention enables the search engine database to collect dynamic web page access information by sending web page access information to it. As the collected information shows statistics about actual web page access information usage, it is an important reference for the search engine to sequence web pages.

### CROSS-REFERENCE TO RELATED APPLICATIONS

This application claims the benefit under 35 U.S.C. §119(a)-(d) of Chinese Application 200810247454.3 filed on Dec. 31, 2008.

### TECHNICAL FIELD

This invention relates in general to the field of Internet technology and, more particularly, to a method and an apparatus for information collection.

### BACKGROUND OF THE INVENTION

Search engine technology greatly facilitates information search on the ever growing Internet.

Current search engines such as Google and Baidu use web crawler programs such as Crawler and Spider to collect information from the Internet. A web crawler program uses a list of the URLs of some web portals to obtain the contents of the corresponding web pages, gets information such as the keywords of the contents to compose a database to be used by the search engine, and the URLs to other resources from the web pages, and then uses the new URLs to perform another information collection operation.

The search process can continue essentially unabated, as the Internet is immense. To end a search process, the search engine uses an algorithm, such as a limit to the search depth. The search engine establishes a comprehensive information database. When a user inputs a keyword, the search engine performs a database lookup and returns the results to the user to end the search process.

At present, most web portals provide both static and dynamic web pages. Dynamic web pages are temporarily generated by the web server according to the input and selection operations of the user and some user related information. Static web pages are already existent. The number of dynamic web pages is much larger than the number of static web pages. Dynamic pages enable web portals to provide more contents and services, but complicate the work of search engines.

Web crawler programs are unable to perform input and selection operations to open dynamic web pages, and thus cannot collect dynamic web page access information. A technology to collect dynamic web page access information in the search engine database is urgently needed.

### SUMMARY OF THE INVENTION

This invention is aimed at providing a method and an apparatus for collecting information such as dynamic web page access information.

The technical solution of this invention is implemented as follows.

The invention provides an information collection method, comprising:

obtaining web page access information, including HTML files, corresponding to the web pages; and

sending the web page access information to a search engine database.

This invention provides an information collection apparatus, comprising an obtaining unit and a sending unit.

The obtaining unit obtains web page access information, and sends such information to the sending unit. The information includes HTML files corresponding to the browsed web pages.

The sending unit sends the received information to the search engine database.

The method and apparatus for information collection provided by the invention enables the search engine database to collect dynamic page information by sending web page access information to the search engine. Thus, the search engine can work with the web server to provide more correct and timely search contents to users. Additionally, as the information sent to the search engine database is obtained from the web server, this invention can better solve the copyright and privacy issues.

In addition, as the technical solution of this invention obtains web page access information, the collected information truly shows choices made by users. Because the most frequently browsed web pages are important, the collected information is very helpful for the search engine to sequence web pages more correctly than any math method or manual adjustment method.

### BRIEF DESCRIPTION OF THE DRAWINGS

FIG. 1 is the block diagram of the information collection apparatus of the invention.

FIG. 2 is the flow chart of the information collection method according to an embodiment of the present invention.

### DETAILED DESCRIPTION OF THE EMBODIMENTS

This invention provides an information collection method, which obtains web page access information, including the HTML files corresponding to the browsed web pages, and sends such information to the search engine database. HTML files include both static and dynamic web pages browsed by users. Thus this method enables the search engine database to collect dynamic web page access information on the web server.

To provide more information to the search engine database, the collected web page access information also includes the client IP address, server IP address, URL and browse time. Thus, obtaining web page access information comprises: obtaining the IP address of the web client, the IP address of the web server, the browse time and the HTML files corresponding to the web pages sent from the server to the client. It further comprises: counting the number of times the user browses each web page within a certain period. The browse time can be the time when the user last browses a web page.

The amount of user-browsed web pages can be very large. To reduce the amount of collected information, this invention can code the HTML files obtained from the web server, create a coding dictionary, and store relations between the HTML files and codes in the coding dictionary. In this way, the technical solution implemented by an embodiment of this invention can either provide the HTML files corresponding to the browsed web pages to the search engine database, or code such HTML files according to the coding dictionary and provide the codes to the search engine database. Prior to sending the web page access information to the search engine database, the implemented technical solution uses the codes to get the corresponding HTML files from the coding dictionary, and sends the HTML files to the search engine database.

As described above, web pages are either static or dynamic. Static web pages have fixed format and do not change. Thus, each static web page can be coded. Dynamic web pages are generated according to choices made by users. Thus, if each dynamic web page is coded, the coding dictionary can become very large. To reduce the size of the coding dictionary, dynamic web pages are coded as follows.

Generally, a dynamic web page comprises a web page template and variables, which can be coded separately. The relation of the web page template, variables and codes is recorded in the coding dictionary. For example, a dynamic web page showing “the price of A is 60 yuan” comprises the template “the price of X is Y yuan” and variables X and Y. X represents the name of the commodity and Y represents the price of the commodity. Thus, the process of coding the dynamic web page is to code the template and variables X and Y.

Thus, the codes corresponding to the dynamic web page can be obtained according to the process by which the web server creates the dynamic web page based on the web page template and variables and the codes corresponding to the web template and variables in the coding dictionary. Variables X and Y have no fixed values. Therefore, to enable the search engine database to get the dynamic web page by using the codes, in addition to sending the codes corresponding to the web page template and variables, the implemented technical solution obtains the values of the variables of the dynamic web page. The implemented technical solution also uses the codes to get the corresponding web page template and variables from the coding dictionary, regenerates the HTML files by using the web page template, variables and values of the variables, and then sends them to the search engine database.

When the web server provides new HTML files, the implemented technical solution codes such files and stores the relations between the HTML files and codes in the coding dictionary, which is used when users access the corresponding web pages. When the web server no longer provides a web page, the implemented technical solution removes the corresponding entry in the coding dictionary to save space. The coding dictionary can be updated either manually or by a specific coding unit.

To reduce data sending times, the implemented technical solution of this invention can put information about multiple web pages that the user browses on the web server into a single message and send the message to the search engine database.

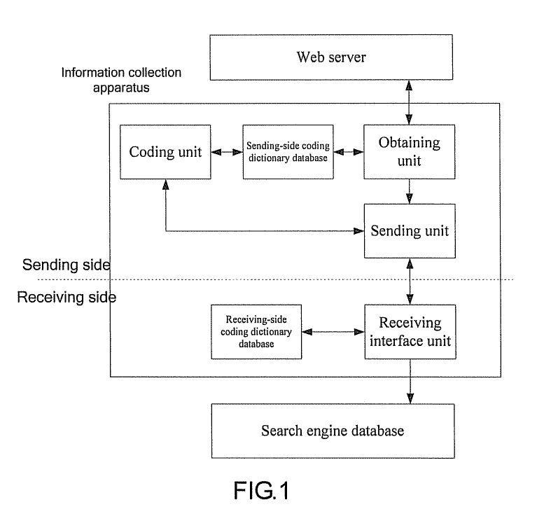

The information collection apparatus, as shown in FIG. 1, comprises an obtaining unit and a sending unit. The obtaining unit obtains web page access information that includes the corresponding HTML files and provides such information to the sending unit. The sending sends the received information to the search engine database.

The obtaining unit can further obtain the web client IP address, the web server IP address, the URL and the browse time and send such information to the sending unit. It can also count the number of times that the user browses a web page within a certain period, and provide such information to the sending unit. The browse time is the time when the user last browses a web page.

In addition, the apparatus can further comprise a receiving-side coding dictionary database, a sending-side coding dictionary database and a receiving interface unit. The receiving-side and sending-side coding dictionary databases store the HTML files and the corresponding codes provided by the web server. The obtaining unit replaces the HTML files from the web server with the corresponding codes in the receiving-side coding database, and provides the web page access information carrying such codes to the sending unit. The receiving interface unit receives the web page access information sent from the sending unit to the search engine database, obtains the corresponding HTML files from the sending-side coding dictionary database by using the codes carried in the web page access information, and sends the web page access information carrying the HTML files to the search engine database.

For a dynamic web page, the receiving-side and sending-side coding dictionary databases also store the codes of the web page template and variables of the dynamic web page when obtaining the codes of the dynamic web page. The obtaining unit (1) gets the codes of the dynamic web page according to the process by which the web server creates the dynamic web page based on the web page template and variables and the codes corresponding to the web template and variables in the sending-side coding dictionary, (2) gets the values of the variables based on the content of the dynamic web page, (3) uses the obtained codes and values of the variables to replace the corresponding HTML files, and (4) sends such information to the sending unit. The receiving interface unit, after receiving the codes of the dynamic web page, (1) gets from the receiving-side coding dictionary the web page template and variables corresponding to the codes, (2) uses the template, variables and values of the variables to regenerate the HTML files, and then (3) sends the information carrying the HTML files to the search engine database.

The apparatus also comprises a coding unit. The coding unit codes the HTML files received from the web server, and sends the HTML files and codes to the sending-side and receiving-side coding dictionary databases. It also updates the codes in the sending-side and receiving-side coding dictionary databases.

The obtaining unit can put information about multiple web pages that a user browses on a web server into a single message and send the message to the sending unit.

In the information collection apparatus, the coding unit, the sending-side coding dictionary database, the obtaining unit and the sending unit comprise the sending side; the receiving interface unit and receiving-side coding dictionary database comprise the receiving side. Because the search engine database needs to collect information from web servers at different sites and of different vendors, the sending side units can be deployed at each web server side. The receiving side and the sending side are deployed in one-to-multiple mode in practice.

The following example embodiment of this invention illustrates an implementation of the technical solution in detail.

The embodiment establishes coding dictionaries containing a code table as shown below, which comprises multiple code entries. Each code entry comprises an entry ID field and an entry content field at least, and may contain the entry content length and entry priority.

TABLE 1

| | | | |
|---|---|---|---|
| Entry 1 | Length 1 | Priority 1 | Entry content 1 |
| Entry 2 | Length 2 | Priority 2 | Entry content 2 |
| Entry 3 | Length 3 | Priority 3 | Entry content 3 |

. . .

| | | | |
|---|---|---|---|
| Entry n | Length n | Priority n | Entry content n |

An entry ID uniquely identifies an HTML file provided by a web server. When a set of web servers provide web services, the form of entry ID+web server IP address can be taken. The entry ID field can occupy 32 bits, that is, four bytes. Coding of HTML files is described above. The entry length field can occupy 32 bits. An entry length of 0xFFFFFFFF indicates the entry is a variable entry, whereby the content field is dynamically generated by the web server according to the choice made by the user and thus is empty. The priority field can occupy 8 bits, and thus a total of 256 priorities are available. The larger the value, the higher the priority. The priority field is helpful for the search engine to sequence web pages more correctly. The length of the content field depends on the entry length. An entry length 0xFFFFFFFF indicates a variable in a dynamic web page. Therefore, a content field is effective only when the entry length is 0-0xFFFFFFFE and it stores the content of the HTML file corresponding to the entry ID.

The technical solution implemented by the embodiment can avoid coding unimportant and private web pages. Thus, the search engine will not find them, and the purposes of protecting privacy, highlighting important information, and reducing the size of the search engine database are achieved.

Upon startup, a web server can report coding dictionaries to the sending-side and receiving-side coding dictionary databases. In addition, when the web server has web page updates, it can send such information to the sending-side and receiving-side coding dictionaries. This invention provides three types of messages for dictionary maintenance, namely, add, update and delete messages. An add or update message contains effective entry ID, length and content fields, while a delete message can contain the entry ID field only.

TABLE 2

| Message type | Description | Effective fields |
|---|---|---|
| Add | For adding a new entry | Entry ID, length, |
| | | content |
| Update | For updating an existing entry | Entry ID, length, |
| | | content |
| Delete | For deleting an existing entry | Entry ID |

The coding dictionary format and content described above are used in an embodiment of this invention and thus vary with solutions.

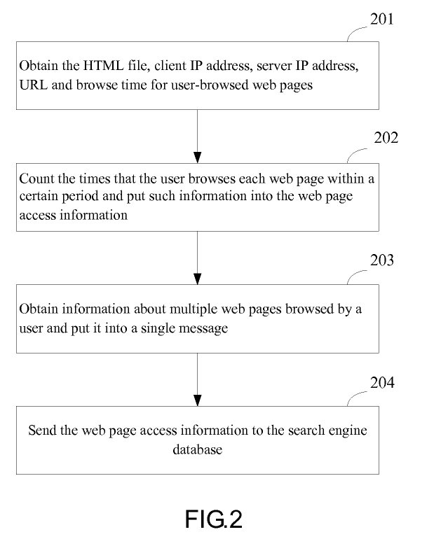

After creating the coding dictionaries, this embodiment can collect information following the flow chart as shown in FIG. 2. In this embodiment, information about a browsed web page comprises the HTML file, client IP address, server IP address, URL, browse time and browse count.

At step 201, the embodiment obtains the IP address of the web client, the IP address of the web server, the URL of the browsed web page, browse time and the corresponding HTML file the web server sends to the web client.

The obtaining unit of the information collection apparatus listens to the TCP connections between the web client and web server for HTTP information to get the client IP address, server IP address, URL and browse time. More specifically, when a web server establishes a TCP connection with a web client, the obtaining unit records the client IP address, server IP address and connection establishment time. When the web server receives a GET request from the web client, the obtaining unit records the URL information and the GET request time. In versions before HTTP1.0, a TCP connection supports one HTTP session. In versions later than HTTP1.1, a TCP connection can support multiple HTTP sessions. That is, when an HTTP session ends, the user may use the TCP connection to create another HTTP session, and the web server can continue to collect corresponding information. When the TCP connection closes, the web server completes an information collection process.

When the web server prepares the HTML file of either a static or dynamic web page, the obtaining unit of the information collection apparatus can get the corresponding codes from the coding dictionary. The obtaining unit gets the codes and values of the variables of a dynamic web page according to the process by which the web server creates the dynamic web page based on the web page template and variables and the codes corresponding to the web template and variables in the coding dictionary. The obtaining unit gets the codes of a static web page from the coding dictionary directly and replaces the HTML file with the codes.

At step 202, the embodiment counts the number of times the user browses the web page within a certain period and puts such information into the web page access information. The browse time can be the time when the user last browses the web page.

The certain period can be set based on the browse frequency or experience.

At step 203, the embodiment puts information about multiple web pages browsed by a user in to a single message.

The obtaining unit of the information collection apparatus can continuously listen to the messages exchanged between the web server and client, and put the listening results obtained within a certain period in to a single message. The single message may take one of the formats as shown in Tables 3, 4 and 5 or some other format.

TABLE 3
Server IP
Client IP

| | |
|---|---|
| msg_count | msg0 |

msg1
msg2
...
msg [msg_count−1]

In Table 3, Server IP and Client IP are both 32 bits long. msg_count refers to the number of messages contained in the message and is 6 bits long. Thus, the message can contain up to 65,535 messages. Msgx represents a message, which describes a specific web page browsed by the client.

The msg format is shown in Table 4.

TABLE 4

| | |
|---|---|
| url_len | url... |

url...
access_time

| | |
|---|---|
| access_count | dict_count |

dict_item0
dict_item1
...
dict_item[dict_count−1]

In Table 4, url_len is the length of the URL character string and is 16 bits long. Ulr is the URL character string. access_time is the time when the user browses the web page. If the user browses the web page multiple times, the time when the user last browses the web page is recorded. access_count is the number of times the user browses the web page. dict_count is the number of dictionary entries contained in the message, that is, the dictionary entries comprising the web page. dict_itemx represents a dictionary entry, which includes the entry ID, and if the entry is a variable, the value of the variable. Table 5 shows the dict_item format.

TABLE 5

dict_index
value_len
value

In Table 5, dict_index is the dictionary entry ID; value_len is the number of characters of the variable entry content. dict_index takes a value of 0 when it represents a common entry, and then the value field is empty. This is because the codes for a common entry correspond to a unique content field and the receiving interface unit at the receiving side can get the unique content from the coding dictionary. If dict_index represents a variable entry, the value field is the value of the variable. The template of a dynamic web page is a common entry.

Before sending the codes for a dynamic web page, the solution needs to get the values of the variables based on the content in the web page. Then, it sends out the codes of the template and variables and the values of the variables.

Besides sending messages containing web page access information to the receiving interface unit, the sending unit also sends to it messages for dictionary maintenance. The message format can contain a 2-byte message type field, a 2-byte message length field and the message body filed. The types of these messages are described in Table 6.

TABLE 6

| Message | Type | Description |
|---|---|---|
| MSGTYPE_ADD_DICT | 1 | For adding a dictionary entry |
| MSGTYPE_MOD_DICT | 2 | For modifying a dictionary entry |
| MSGTYPE_DEL_DICT | 3 | For deleting a dictionary entry |
| MSGTYPE_UA_INFO | 4 | Code information of the browsed |
| | | web page |

At step 204, the embodiment sends the web page access information to the search engine database.

As a coding technology is used to store the web page access information, a process of decoding the information is needed before the information can be sent to the search engine database. For a static web page, the receiving interface unit of the information collection apparatus gets the HTML file corresponding to the codes from the receiving-side coding dictionary database. For a dynamic web page, the receiving interface unit gets the web page template and variables corresponding to the codes from the receiving-side coding dictionary database and regenerates the HTML file according to the web page template, variables and values of the variables.

The receiving interface unit can directly send dictionary request messages to the sending unit. The request format contains a 2-byte command type field, a 2-byte message length field, and the message body field. For a message type, the command type can be 1, the message length can be 0, and the message body can be nonexistent. When the coding unit receives a dictionary request from the receiving interface unit through the sending unit, it can send the current codes to the receiving interface unit, which can use such information to maintain the coding dictionary.

Generally, the sending side and receiving side in the information collection apparatus exchange information over the Internet, and the receiving interface unit receives messages carrying codes from the Internet. Thus, security measures must be taken to defend against attacks. The available measures include hierarchical authentication, capacity limitation, and receiving rate limitation. For example, a fixed domain name can be set for the sending unit configured for each web server, and thus the receiving interface unit can authenticate a sending unit by using its domain name. To implement receiving rate limitation, the receiving interface unit can adopt different authentication levels for different sending sides depending on their trust level, information rates and integrity, and assign different information receiving rates to them; the trust levels can be set based on the times that users browse web pages. In addition, the receiving interface unit can save the web page access information received from sending sides within a certain period and send such information to the search engine database. In this way, the receiving interface unit can effectively limit the capacity of the information received from each sending side. When the capacity limit is reached, new information will overwrite old information or low-priority information. This method not only limits the capacity of web page access information on the search engine database, but also improves information importance and timeliness.

The technical solution of the preceding embodiment of this invention enables the search engine database to collect dynamic web page access information by sending web page access information to it. Additionally, as the web page access information used by the search engine database is sent from the sending side residing on the web server side, this technical solution effectively avoids copyright and privacy issues. The web server can highlight its important web pages by using code priorities or ignore the codes of some pages. Thus, the web server and the search engine work together to provide correct and timely search results to users.

In addition, as the technical solution of this invention obtains web page access information, the collected information truly shows the choices made by users. Because the most frequently browsed web pages are important, the collected information is very helpful for the search engine to sequence web pages more correctly than any math method or manual adjustment method.

Although an embodiment of the invention is described in detail, a person skilled in the art could make various alternations, additions, and omissions without departing from the spirit and scope of the present invention as defined by the appended claims.

1-20. (canceled)

21. A method of collecting information, comprising:
at an obtaining unit of an information collecting apparatus communicatively coupled with a web server, listening to an HTML transaction between a web client and the web server;
by listening to the HTML transaction, obtaining web page access information from the HTML transaction, the web page access information including one or more HTML files, each corresponding to one or more web pages of the HTML transaction; and
at the obtaining unit, sending the obtained web page access information to a search engine database that is communicatively coupled with the information collecting apparatus.

22. The method of claim 21, wherein the web page access information comprises a client IP address, a server IP address, a URL for each of the one or more web pages included in the HTML transaction, a respective browse count for each of the one or more web pages included in the HTML transaction, and a respective browse time for each of the one or more web pages included in the HTML transaction,
and wherein obtaining the web page access information comprises obtaining the one or more HTML files sent from the web server to the web client for the one or more web pages of the HTML transaction.

23. The method of claim 22, wherein obtaining the web page access information further comprises:
respectively counting a number of times the web client browses each of the one or more web pages within a given period;
setting the respective browse count to the respective counted number; and
setting the respective browse time to a most recent time at which the web client respectively browsed each of the one or more web pages.

24. The method of claim 21, further comprising:
coding each of the one or more HTML files obtained from the web server to yield respective codes corresponding to each of the one or more HTML files; and
recording in a coding dictionary each of the one or more HTML files and the respective codes corresponding to each of the one or more HTML files.

25. The method of claim 24, wherein obtaining the web page access information from the HTML transaction comprises using the coding dictionary to replace in the web page access information each of the one or more HTML files with the respective codes corresponding to each of the one or more HTML files,
and wherein sending the obtained web page access information to the search engine database comprises using the coding dictionary to regenerate the each of the one or more HTML files from the respective codes corresponding to each of the one or more HTML files, and sending the regenerated one or more HTML files to the search engine database.

26. The method of claim 25, wherein at least one of the one or more HTML files is a dynamic HTML file corresponding to one or more dynamic web pages,
wherein coding the dynamic HTML file comprises coding one or more web page templates and one or more variables of the one or more dynamic web pages,
wherein recording in the coding dictionary the dynamic HTML file and the respective codes corresponding to the dynamic HTML file comprises recording in the coding dictionary dynamic web page codes corresponding to (i) the one or more web page templates and (ii) the one or more variables, and further recording relations between the one or more web page templates, the one or more variables, and the one or more dynamic web pages,
wherein using the coding dictionary to replace in the web page access information the dynamic HTML file with the respective codes corresponding to the dynamic HTML file comprises:
obtaining from the coding dictionary the dynamic web page codes, and further obtaining the relations between the one or more web page templates, the one or more variables, and the one or more dynamic web pages;
obtaining values of the one or more variables according to contents of the one or more dynamic web pages; and
replacing the dynamic HTML file with the dynamic web page codes, and with the values of the one or more variables,
and wherein using the coding dictionary to regenerate the dynamic HTML file from the respective codes corresponding to the dynamic HTML file comprises:
obtaining from the coding dictionary the dynamic web page codes, and further obtaining the relations between the one or more web page templates, the one or more variables, and the one or more dynamic web pages; and
using and values of the one or more variables, the dynamic web page codes, and
the relations between the one or more web page templates, the one or more variables, and
the one or more dynamic web pages to generate HTML files.

27. The method of claim 24, further comprising:
obtaining one or more additional HTML files by listening to one or more additional HTML transactions between the web server and one or more additional web clients;
coding each of the one or more additional HTML files to yield respective codes corresponding to each of the one or more additional HTML files; and
recording in the coding dictionary each of the one or more additional HTML files and the respective codes corresponding to each of the one or more additional HTML files.

28. The method of claim 21, wherein sending the obtained web page access information to a search engine database comprises:
putting web page access information corresponding to multiple HTML transactions between the web client and the web server into a single message;
and sending the single message to the search engine database.

29. An information collection apparatus configured to be communicatively coupled with a web server, the information collection apparatus comprising an obtaining unit and a sending unit,
wherein, the obtaining unit is configured to:
listen to an HTML transaction between the web server and a web client;
obtain web page access information from the HTML transaction, the web page access information including one or more HTML files, each corresponding to one or more web pages of the HTML transaction; and
send the web page access information to the sending unit,
and wherein the sending unit is configured to send the obtained web page access information to a search engine database that is communicatively coupled with the information collecting apparatus.

30. The information collection apparatus of claim 29, wherein the obtaining unit is further configured to:
obtain additional information comprising an IP address of the web client, an IP address of the web server, a URL for each of the one or more web pages included in the HTML transaction, a respective browse count for each of the one or more web pages included in the HTML transaction, and a respective browse time for each of the one or more web pages included in the HTML transaction; and
include the additional information in the web page access information sent to the sending unit.

31. The information collection apparatus of claim 30, wherein the obtaining unit is further configured to:
respectively count a number of times the web client browses each of the one or more web pages within a given period;
set the respective browse count to the respective counted number; and
set the respective browse time to a most recent time at which the web client respectively browsed each of the one or more web pages.

32. The information collection apparatus of claim 29, further comprising a receiving-side coding dictionary database, a sending-side coding dictionary database, and a receiving interface unit,
wherein the receiving-side coding dictionary database and the sending-side coding dictionary database are each configured to store respective codes corresponding to the one or more HTML files,
wherein the obtaining unit is configured to send the web page access information to the sending unit by being configured to use the sending-side coding dictionary database to get the respective codes corresponding to the one or more HTML files, and to replace in the web page access information sent to the sending unit the one or more HTML files with the respective codes,
and wherein the receiving interface unit is configured to:
receive the web page access information sent from the sending unit;
use the receiving-side coding dictionary database to get the one or more HTML files corresponding to the respective codes contained in the web page access information; and
send the one or more HTML files to the search engine database.

33. The information collection apparatus of claim 32, wherein the receiving-side coding dictionary database and the sending-side coding dictionary database are each further configured to record codes of one or more dynamic web pages by storing dynamic web page codes corresponding to (i) one or more web page templates and (ii) one or more variables of the one or more dynamic web pages, and to further store relations between the one or more web page templates, the one or more variables, and the one or more dynamic web pages,
wherein being configured to use the sending-side coding dictionary database to get the respective codes corresponding to the one or more HTML files comprises being configured to:
obtain from the receiving-side coding dictionary database the dynamic web page codes, and further obtain the relations between the one or more web page templates, the one or more variables, and the one or more dynamic web pages; and
obtain values of the one or more variables according to contents of the one or more dynamic web pages,
wherein the sending unit is further configured to determine values of the one or more variables according to contents of the one or more dynamic web pages,
wherein being configured to replace in the web page access information sent to the sending unit the one or more HTML files with the respective codes comprises being configured to replace the one or more HTML files with the dynamic web page codes, and with the values of the one or more variables,
and wherein the receiving interface unit is configured to use the receiving-side coding dictionary database to get the one or more HTML files and to send the one or more HTML files to the search engine database by being configured to:
get from the receiving-side coding dictionary the one or more web page templates and the one or more variables corresponding to the dynamic web page codes in the web page access information;
regenerate the one or more HTML files by using the one or more web page templates, one or more variables, and the values of the one or more variables; and
send the regenerated one or more HTML files to the search engine database.

34. The information collection apparatus of claim 32, further comprising a coding unit configured to:
code the one or more HTML files to yield the respective codes corresponding to the one or more HTML files;
send the one or more HTML files and the respective codes to the sending-side dictionary database and to the receiving-side coding dictionary database; and
update the respective codes in the sending-side dictionary database and the receiving-side coding dictionary database.

35. The information collection apparatus of claim 29, wherein the obtaining unit is further configured to:
obtain compound information about multiple web pages browsed by a user via a web client;
put the compound information in a single message; and
send the single message to the sending unit.

36. A method for collecting information for search engine comprising:
at an information collecting apparatus communicatively coupled with a first web server, receiving one or more first messages from the first web server, the one or more first messages corresponding to one or more HTML transactions between the first web server and an internet client, and each of the one or more first messages including codes that represent one or more first HTML files corresponding to one or more web pages sent from the first web server to the internet client, wherein each of the one or more first HTML files is coded with unique codes;
at the information collecting apparatus, retrieving the one or more first HTML files from the one or more first messages according to a first coding dictionary associated with the first web server.

37. The method of claim 36, wherein the information collection apparatus is communicatively coupled with a second web server, the method further comprising:
at the information collection apparatus, receiving one or more second messages from the second web server, the one or more second messages corresponding to one or more HTML transactions between the second web server and an internet client, and each of the one or more second messages including codes that represent one or more second HTML files corresponding to one or more web pages sent from the second web server to the internet client, wherein each of the one or more second HTML files is coded with unique codes;
at the information collecting apparatus, retrieving the one or more second HTML files from the one or more second messages according to a second coding dictionary associated with the second web server, wherein the second coding dictionary is different from the first coding dictionary.

38. The method of claim 36, wherein each of the one or more first messages further comprises an IP address of the internet client, an IP address of the first web server, a URL for each of the one or more web pages, a respective browse count for each of the one or more web pages, and a respective browse time for each of the one or more web pages.

39. The method of claim 38, wherein the respective browse count corresponds to a respective number of times each of the one or more web pages was browsed by the internet client within a give period,
and wherein the respective browse time corresponds to a most recent time at which the internet client respectively browsed each of the one or more web pages.

40. The method of claim 36, wherein at least one of the one or more first HTML files is a dynamic HTML file corresponding to one or more dynamic web pages,
wherein the unique codes of the dynamic HTML file comprises codes of a page template that is coded according to the first coding dictionary,
wherein the dynamic HTML file is included a particular one of the one or more first messages,
and wherein and the particular one of the one or more first messages further comprises variables of the one or more dynamic web pages.

41. The method of claim 36, further comprising:
updating the first coding dictionary according to information from the first web server.
